(19) United States
(12) Patent Application Publication
(10) Pub. No.: US 2008/0266288 A1
(43) Pub. Date: Oct. 30, 2008

(54) ElementSnapshot Control

(75) Inventor: Joshua D. Wagoner, Tacoma, WA (US)

Correspondence Address: LEE & HAYES, PLLC, 421 W. RIVERSIDE AVE, STE 500, SPOKANE, WA, 99201, US

(73) Assignee: IdentityMine Inc., Tacoma, WA (US)

(21) Appl. No.: 11/741,591

(22) Filed: Apr. 27, 2007

(51) Int. Cl. G06F 17/00; G06F 15/00; G06T 15/00

(52) U.S. Cl. 345/419

(57) ABSTRACT

An ElementSnapshot control receives an element from windows presentation foundation (WPF) that is used to render a bitmap image. A determination is made by the control whether or not the bitmap image has been previously generated. If the bitmap image has been previously generated, the control retrieves the generated bitmap. If the image has not been previously generated, the control supplies the element to a native WPF class in order to generate the bitmap of the element. The generated bitmap is then rendered into a WPF scene.

### BACKGROUND

Windows Presentation Foundation (WPF) is Microsoft Corporation's (of Redmond, Wash.) presentation subsystem for .NET 3.0, which is a key part of the Microsoft Windows Vista operating system. In WPF, applications can operate over many types of data, including simple objects, collection objects, WPF elements, XML data, ADO.NET objects, and objects returned from Web services. To facilitate data visualization and interaction, WPF implements a mechanism that allows the declaratively binding of these types of data sources to an application user interface (UI). More information is available online within the Microsoft Developer Network (MSDN) documentation for WPF at http://msdn2.microsoft.com/en-us/library//aa970268.aspx.

WPF natively provides a way to insert bitmaps into a UI scene or to insert live user interface elements into a scene. WPF does not natively provide a way for a designer or developer to insert into their scene a bitmap that is generated from live content that can be easily regenerated and toggled between a static bitmap and live interactive content.

### SUMMARY

A framework element (also referred to herein as an element) is received by an ElementSnapshot control from windows presentation foundation (WPF) that is used to render a bitmap image. A determination is made by the control whether or not the bitmap image has been previously generated. If the bitmap image has been previously generated, the control retrieves the generated bitmap from a cache. If the image has not been previously generated, the control supplies a native WPF class the element to generate the bitmap. The generated bitmap is then rendered into a WPF scene. Using ElementSnapshot enables a designer or developer to insert into their scene a bitmap that is 1) generated from live content that can be easily regenerated and 2) switched between a static bitmap and live interactive content

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram depicting a simplified block diagram of the ElementSnapshot control functionality.

FIG. 2 is a block diagram depicting selected modules in a computer device that invokes the ElementSnapshot Control.

FIG. 3 is a diagram of an exemplary process used to implement the ElementSnapshot control.

FIG. 4 is an illustration of a sample bitmap generated using the ElementSnapshot control.

### DETAILED DESCRIPTION

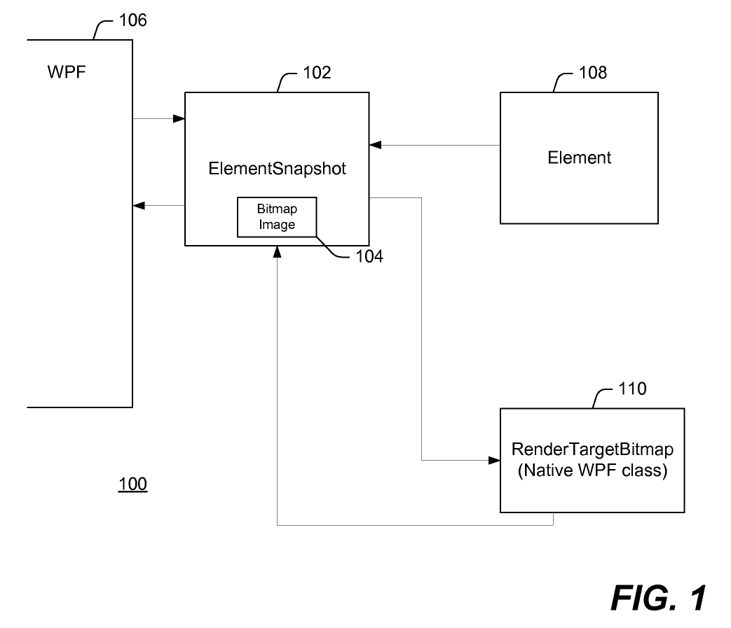

This disclosure is directed to an ElementSnapshot software component for WPF that allows a designer or developer to easily insert into their WPF application static bitmaps generated from any WPF framework element into a scene. The control supports regeneration of bitmaps at a configurable interval as well as allowing the designer or developer to specify that the static bitmap should be replaced with live content that is fully interactive with the end user and dynamically renders for every frame. ElementSnapshot generates a bitmap from the WPF framework element that it is given. ElementSnapshot caches the bitmap and renders it each time ElementSnapshot is asked to render content. In this document the term bitmap can refer to any raster image format, examples of which include BMP, JPEG, TIFF, GIF, or PNG. Various examples of are described below with reference to FIGS. 1-4.

FIG. 1 illustrates an example system 100 in which ElementSnapshot component 102 is used to create a bitmap image 104 for WPF 106. The ElementSnapshot component 102 is coupled to Element 108 and RenderTargetBitmap 110, which is a native WPF class.

### Example System Architecture

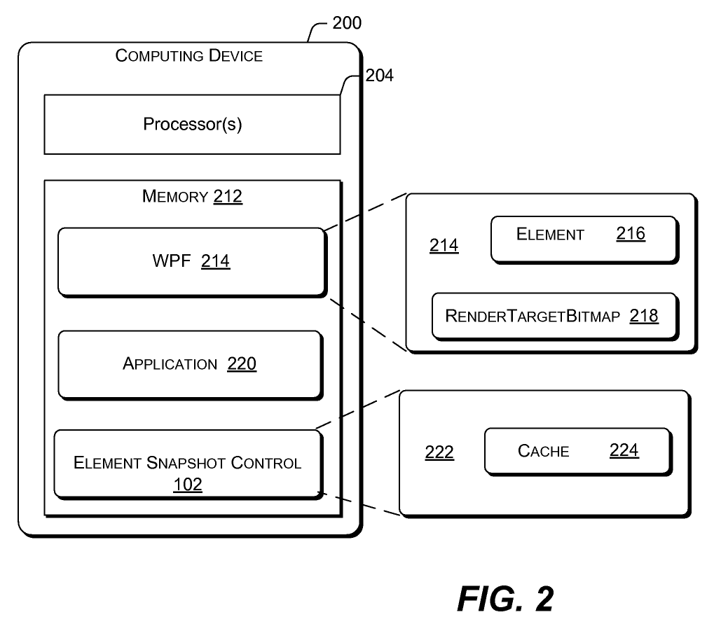

In FIG. 2 are illustrated selected modules in computing device 200 for implementing the ElementSnapshot control. Computing device 200 has process capabilities and memory suitable to store and execute computer-executable instructions. In one example, computing device 200 includes one or more processors 204 and memory 212.

The memory 212 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 212 of the computing device 200 is Windows Presentation Foundation 214 with an operating system (Such as a Window® Vista based operating system), an ElementSnapshot control 102 and a software application 220. ElementSnapshot control 102 (also generally referred to as “ElementSnapshot class” or “ElementSnapshot”) includes cache. WPF 214 includes element 216 and RenderTargetBitmap class 218.

ElementSnapshot control 102 receives a request from WPF to render itself into the scene. Upon receiving the request it determines if it currently has a generated bitmap of the WPF Framework Element in cache 224. In one implementation the ElementSnapshot 102 uses a simple reference to the generated bitmap and if that reference is set to null it knows that there is no current generated bitmap. If it does not currently have a bitmap in cache 224, ElementSnapshot 102 uses the WPF RenderTargetBitmap class 218 to render the element into a bitmap the size of the space occupied by the ElementSnapshot control 102, and control 102 caches that bitmap.

The Element property 216 sets the Framework element on the ElementSnapshot 102.

RenderTargetBitmap 218 renders the Element 216 into a bitmap the size of the space occupied by ElementSnapshot control and caches that bitmap in cache 224.

After bitmap is generated, ElementSnapshot 102 renders that bitmap directly into the area that it occupies in the visual scene (taking into consideration any overflow specified in the ElementOverflow property), via a call to a DrawImage method of the WPF DrawingContext class. If a cached bitmap does exist ElementSnapshot 102 renders that bitmap into its occupied space via a call to the DrawImage method of the WPF DrawingContext class.

There are several conditions that trigger the cached bitmap to become invalid and for ElementSnapshot 102 to release its reference to the cached bitmap and thus trigger the rendering logic using RenderTargetBitmap 218. ElementSnapshot 102 exposes a property, SnapshotRefreshInterval, which allows the designer or developer to specify to the control how often a new bitmap should be generated. Once the interval has elapsed, the control releases its cached bitmap. Releasing its cached bitmap results in a new bitmap being generated the next time the ElementSnapshot 102 is asked to render itself.

If the Element property 216 on the ElementSnapshot 102 is changed to an entirely new element, the ElementSnapshot 102 will again release its cached image and generate a new bitmap on a next render. Also, anytime the IsLive (discussed below) property is changed from true to false a new bitmap will be automatically generated.

The designer or developer can specify that the ElementSnapshot 102 should no longer render a generated bitmap and instead should allow the WPF element set as the Element property 216 to render itself into the WPF scene. The ElementSnapshot control 102 accomplishes this by returning the element 216 as a Visual child to WPF at which point WPF then requests the element 216 to render itself. This property that controls this behavior on ElementSnapshot 102 is called IsLive. When IsLive is false the ElementSnapshot 102 will render the generated bitmap, and when IsLive is true ElementSnapshot 102 will allow the element 216 to render itself.

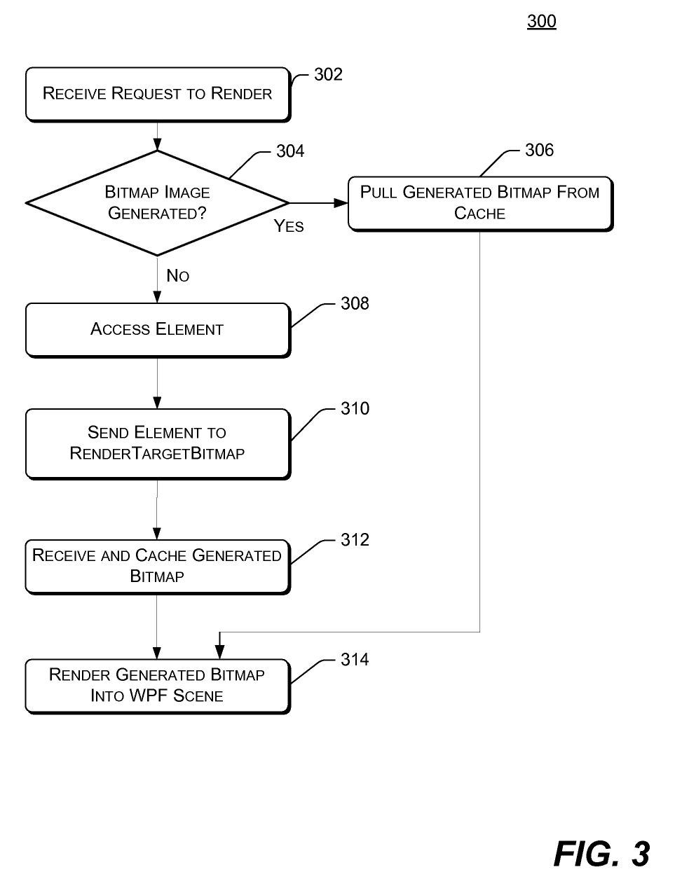

Illustrated in FIG. 3, is a process 300 for invoking an ElementSnapshot control 102. The exemplary process in FIG. 3 is illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 1 and FIG. 2, although it may be implemented in other system architectures.

Referring to FIG. 3, there is shown a process 300 by which ElementSnapshot control 102 inserts into a WPF application for display in a scene static bitmaps generated from a WPF framework element.

The ElementSnapshot 102 periodically receives a request from WPF each time the WPF needs to render the ElementSnapshot. As part of the request, WPF asks the ElementSnapshot 102 to render itself in block 302.

ElementSnapshot 102 makes a determination in block 304 whether a bitmap image was previously generated. If ElementSnapshot 102 already has a valid generated bitmap (“Yes” to block 304) in cache 224, the generated bitmap is pulled from cache 224 in block 306, and the process then proceeds to render the generated bitmap into a WPF scene in block 314. If ElementSnapshot 102 does not have a cached generated bitmap (“No” to block 304), it accesses the WPF element that is set as the Element property 216 by ElementSnapshot 102 in block 308.

The ElementSnapshot 102 then uses the native WPF class, RenderTargetBitmap 218, to render the Element 216 into a bitmap and caches the generated bitmap in internal memory cache 224 in block 310.

In block 312 the Elementsnapshot 102 receives and caches the generated bitmap. In block 314 the ElementSnapshot renders the cached generated bitmap into the space it occupies in the WPF scene via a call to the WPF DrawingContext.DrawImage method. The space may occupy a small portion of the total scene.

### Example Rendering

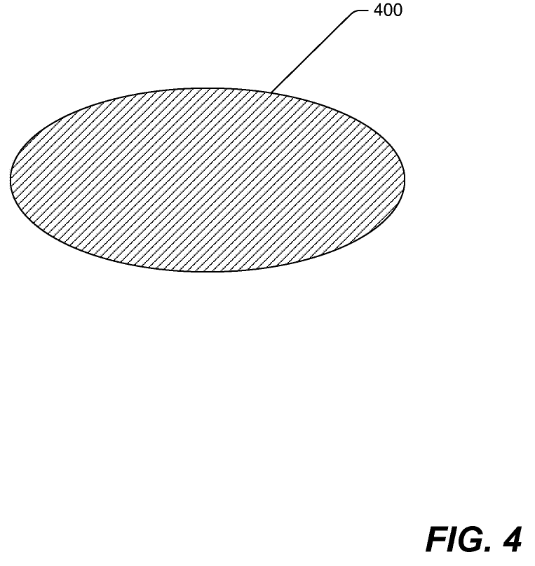

The following extensible application markup language (XAML) markup is an example of using the ElementSnapshot control 102 to insert a dynamically generated bitmap into a user interface. The output of the bitmap is shown as ellipse 400 in FIG. 4.

```
<im:ElementSnapshot ElementOverflow=“4”
Width=“150” Height=“150”>
  <im:ElementSnapshot.Element>
    <Grid>
      <Ellipse Fill=“Red”>
        <Ellipse.BitmapEffect>
          <BlurBitmapEffect />
        </Ellipse.BitmapEffect>
      </Ellipse>
    </Grid>
  </im:ElementSnapshot.Element>
</im:ElementSnapshot>
```

The example demonstrates the ElementSnapshot control 102 being used to render a bitmap generated from a WPF Grid control that contains a red ellipse 400 with a WPF BlurBitmapEffect applied. The Element property 216 (set in the XAML using the NameSpace:TypeName.PropertyName format, e.g.: im:ElementSnapshot.Element) is used to specify what WPF element should be rendered into the generated bitmap. The Width and Height properties on the ElementSnapshot 102 simply indicate the size in pixels that the ElementSnapshot 102 should occupy. The ElementOverflow property indicates to the ElementSnapshot 102 control that the control should allow the generated bitmap to overflow the area that the ElementSnapshot 102 control itself occupies by that many pixels. The ElementOverflow is of the type Thickness (a WPF native type) so that ElementOverflow can specify the overflow on each edge of the space it occupies.

In the example, the value “4” is used to specify 4 pixels on each edge of the ElementSnapshot that can be overflowed, but a value like “2,4,2,4” could be used to specify 2 pixels of overflow on the left, 4 pixels of overflow on the top, 2 pixels of overflow on the right and 4 pixels of overflow on the bottom. The functionality for parsing the string values such as “4” and “2,4,2,3” into actual instances of thickness objects is natively provided by WPF.

### CONCLUSION

In closing, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method for depicting a visual representation in a Windows Presentation Foundation (WPF) scene, the method comprising:
receiving an element from a WPF application that is used to render a bitmap image;
determining whether the bitmap image has been previously generated;
if the image has been previously generated, retrieving the generated bitmap;
if the image has not been previously generated, using a native WPF class to generate the bitmap; and
rendering the generated bitmap into the WPF scene.

2. The method recited in claim 1 further comprising:
caching the generated bitmap in a cache; and
examining the cache when determining whether the bitmap image has been previously generated.

3. The method recited in claim 1 further comprising:
receiving with the element a screen space in with which to render a bitmap; and
rendering the generated bitmap into the WPF scene within the screen space.

4. The method as recited in claim 1 further comprising continuously receiving the render requests to re-render the element from the WPF Application each time the application needs to render the bitmap image.

5. The method as recited in claim 1 wherein a format of the bitmap is selected from a group of bitmap formats comprising: BMP, JPEG, TIFF, GIF, and PNG.

6. The method as recited in claim 1 wherein if the image has been previously generated, retrieving the generated bitmap from a cache.

7. The method as recited in claim 1 wherein the generated bitmap is rendered for insertion into a portion of the WPF scene as indicated by WPF.

8. A computer readable medium comprising computer-executable instructions for depicting a visual representation in a Windows Presentation Foundation (WPF) scene that, when executed by one or more processors, perform acts comprising:
receiving an element from a WPF application that is used to render a bitmap image;
automatically determining whether the bitmap image has been previously generated;
if the image has been previously generated, retrieving the generated bitmap from a cache;
if the image has not been previously generated, using a native WPF class to generate the bitmap; and
rendering the generated bitmap for insertion into the WPF scene.

9. The computer readable medium as recited in claim 8, wherein the bitmap generated using the native WPF class is stored in the cache after being generated.

10. The computer readable medium as recited in claim 8 further comprising:
caching the generated bitmap in a cache using the native WPF class; and
examining the cache when determining whether the bitmap image has been previously generated.

11. A method for depicting a visual representation in a Windows Presentation Foundation (WPF) scene, the method comprising:
periodically receiving one or more elements from a WPF application that are used to render bitmap images;
determining whether one of the bitmap images corresponding to one of the received elements has been previously generated;
if the image has been previously generated, retrieving the generated bitmap corresponding to the one of the received elements;
if the image has not been previously generated, using a native WPF class to generate the bitmap for the received one of the elements; and
rendering the generated bitmap into the WPF scene.

12. The method as recited in claim 10 wherein the bitmap is rendered into the WPF scene via a call to a DrawImage method of a WPF DrawingContext class.

13. The method as recited in claim 10 wherein the native WPF to generate the bitmap is a WPF RenderTargetBitmap class.
